(19) United States
(12) Patent Application Publication
(10) Pub. No.: US 2021/0041614 A1
(43) Pub. Date: Feb. 11, 2021

(54) DISPLAY DEVICE AND OPERATION METHOD THEREOF

(71) Applicant: DAYU OPTOELECTRONICS CO., LTD., TAOYUAN CITY (TW)

(72) Inventors: Yao-Cheng Li, Taoyuan City (TW); Shu-Wei Yang, Taipei City (TW)

(21) Appl. No.: 16/554,545

(22) Filed: Aug. 28, 2019

(30) Foreign Application Priority Data
Aug. 6, 2019 (TW) 108127819

(51) Int. Cl. F21V 8/00; H01B 7/08

(52) U.S. Cl. CPC G02B 6/0006; G02B 6/001; H01B 7/0846

(57) ABSTRACT

A display device is provided, which is arranged by a plurality of optical cables in parallel, and each optical cable comprises includes a conductive material and a light guide material, wherein the light guide material covers the conductive material, and two encapsulated light-emitting elements comprise a first encapsulated light-emitting element and a second encapsulated light-emitting element, which are respectively positioned at two ends of each optical cable, wherein each encapsulated light-emitting element comprises a plurality of light-emitting units, and an area of each light-emitting unit overlaps with an area of the light guide material viewed from a sectional direction.

### BACKGROUND OF THE INVENTION

### 1. Field of the Invention

The invention relates to a display device in detail, in particular to a display device formed by arranging a plurality of optical cables with double-sided luminous functions and an operation method thereof.

### 2. Description of the Prior Art

In recent years, the e-sport industry has developed rapidly, which has also driven the development of software and hardware equipment used by the e-sport industry. As for hardware equipment, in addition to the pursuit of faster computing speed, the modeling of hardware equipment is also constantly innovating, hoping to create products that can attract consumers' attention.

In order to successfully attract the attention of consumers, many products related to electronic competition are combined with light-emitting elements to produce devices with luminous effects, such as mice, keyboards, chassis, mainboards, etc. commonly used in electronic competition activities.

Among them, some products include luminous wires (optical cables). However, judging from the products currently on the market, the luminous colors or patterns of these luminous wires are still too monotonous.

### SUMMARY OF THE INVENTION

The present invention provides a display device, the display device includes a plurality of optical cables arranged parallel with each other, wherein each optical cable wire comprises a conductive material and a light guide material, wherein the light guide material covers the conductive material, and two encapsulated light-emitting elements comprising a first encapsulated light-emitting element and a second encapsulated light-emitting element, which are respectively positioned at two ends of each optical cable wire, wherein each encapsulated light-emitting element comprises a plurality of light-emitting units, and an area of each light-emitting unit overlaps with an area of the light guide material when viewed from a cross-sectional direction.

The present invention provides an operation method of a display device, the operation method including: first, a display device is provided, and the display device includes a plurality of optical cables arranged parallel with each other, wherein each optical cable wire comprises a conductive material and a light guide material, wherein the light guide material covers the conductive material, and two encapsulated light-emitting elements comprising a first encapsulated light-emitting element and a second encapsulated light-emitting element, which are respectively positioned at two ends of each optical cable wire, wherein each encapsulated light-emitting element comprises a plurality of light-emitting units, and an area of each light-emitting unit overlaps with an area of the light guide material when viewed from a cross-sectional direction. Afterwards, the first encapsulated light-emitting element and the second encapsulated light-emitting element are controlled, so that the first encapsulated light-emitting element and the second encapsulated light-emitting element respectively emit light into the light guide material.

One of the features of the present invention is to provide a display device and an operation method thereof, wherein the display device is formed by arranging a plurality of optical cables. Both ends of the same optical cable are respectively provided with encapsulated light-emitting elements, thus achieving the effect of double-sided light emission. Compared with the single-sided light-emitting optical cable, the double-sided light-emitting optical cable has more changes in the presentation of light and shadow effects, and has various light and shadow effects that cannot be presented by single-sided light-emitting optical cable. Therefore, the beauty and value of the product can be increased. In addition, the display device can also display various light and shadow effects or specific patterns according to requirements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an upper view of a light-emitting group according to a preferred embodiment of the present invention.

FIG. 2 is a sectional view taken along section line A-A′ of FIG. 1.

FIG. 3 is a partial perspective view of the light-emitting group.

FIGS. 4A, 4B and 4C show the light and shadow effect of a single optical cable in an embodiment of the present invention.

FIGS. 5A, 5B and 5C show the light and shadow effect of a single optical cable in another embodiment of the present invention.

FIG. 6 shows the light and shadow effect when a display device is formed by arranging a plurality of optical cables side by side using the embodiment shown in FIG. 5C.

FIG. 7, FIG. 8 and FIG. 9 respectively depict patterns presented by the display device at different times according to different embodiments of the present invention.

FIG. 10 shows an upper view of a display device according to another preferred embodiment of the present invention.

### DETAILED DESCRIPTION

To provide a better understanding of the present invention to users skilled in the technology of the present invention, preferred embodiments are detailed as follows. The preferred embodiments of the present invention are illustrated in the accompanying drawings with numbered elements to clarify the contents and the effects to be achieved.

Please note that the figures are only for illustration and the figures may not be to scale. The scale may be further modified according to different design considerations. When referring to the words “up” or “down” that describe the relationship between components in the text, it is well known in the art and should be clearly understood that these words refer to relative positions that can be inverted to obtain a similar structure, and these structures should therefore not be precluded from the scope of the claims in the present invention.

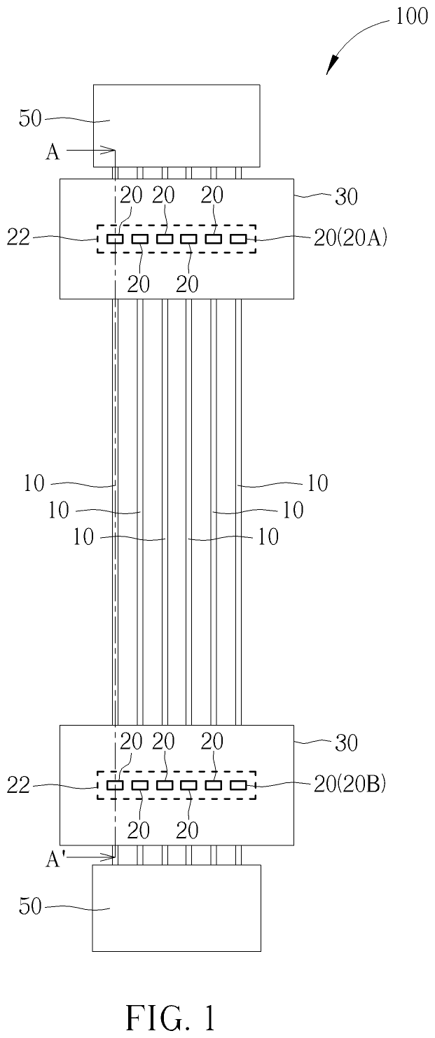

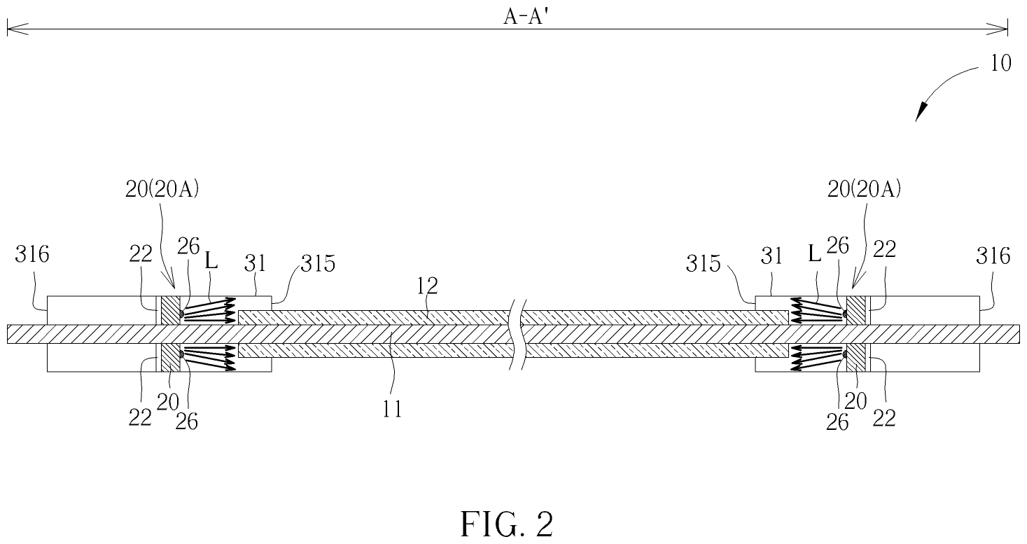

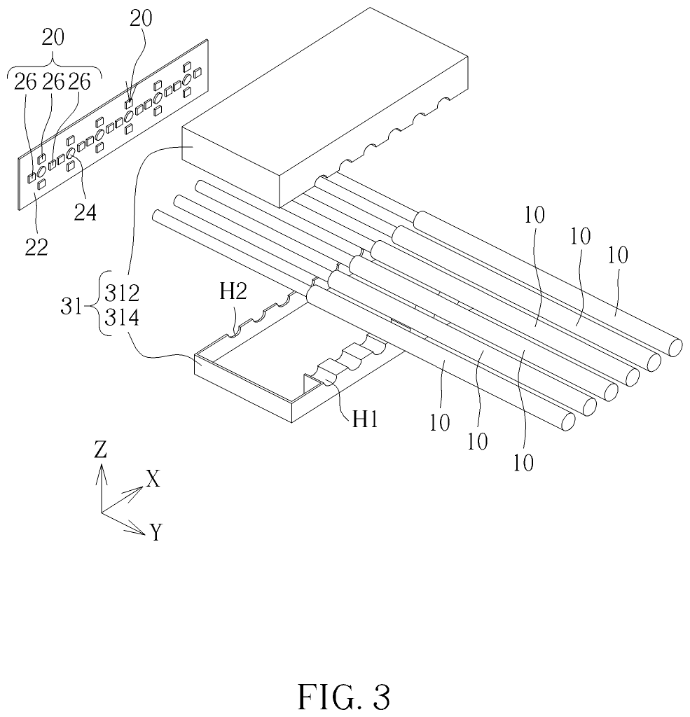

Please refer to FIG. 1, FIG. 2 and FIG. 3, which illustrate a light-emitting group according to a preferred embodiment of the present invention. FIG. 1 shows an upper view of a light-emitting group according to a preferred embodiment of the present invention; FIG. 2 is a sectional view taken along section line A-A′ of FIG. 1; FIG. 3 is a partial perspective view of the display device 100. The display device 100 of the present invention includes a plurality of optical cables. For example, in this embodiment, there are six optical cables 10 parallel to each other. Each optical cable 10 includes a conductive material 11 and a light guide material 12, wherein the light guide material 12 is coated outside the conductive material 11. In this embodiment, the above-mentioned optical cables 10 have the same size, and further, the diameters of the conductive materials 11 of each optical cable also have the same size to each other, and the thicknesses of the light guide materials 12 are the same too, so each optical cable 10 has the same diameter, but the present invention is not limited thereto. In other embodiments, optical cables with different diameters can also be manufactured according to actual requirements, which is also within the scope of the present invention.

In this embodiment, the conductive material 11 is used as the conductive axis of the display device 100 for connecting electrical signals, and the material is, for example, flexible copper wire, silver plated flexible copper wire, etc. The light guide material 12 covers the outer side of the conductive material 11 and is mainly made of transparent or semitransparent materials, such as polycarbonate resin, glass or other suitable materials. At least one conductive material 11 is electrically connected to a power source, such as a power supply in computer equipment.

In addition, except for the conductive material 11, a signal line (not shown) may be included in the light guide material 12 to transmit signals. Therefore, the display device 100 of the present invention can be used as a signal transmission cord, a power cord or a combination of the two.

Please referring to FIG. 2 and FIG. 3, the present embodiment further includes a plurality of encapsulated light-emitting elements 20, each encapsulated light-emitting element, such as a encapsulated light-emitting diode (LED), including a plurality of LEDs (light-emitting units) and some conductive lines. Each optical cable 10 corresponds to at least one or more encapsulated light-emitting elements 20. For example, in this embodiment, each of the optical cable 10 corresponds to four encapsulated light-emitting elements 20, which are located at one end of each of the optical cable 10, and each of the four encapsulated light-emitting elements 20 surrounds each of the optical cable 10, especially the conductive material 11 of each of the optical cable 10.

In this embodiment, each encapsulated light-emitting element 20 is located on a printed circuit board 22, wherein the printed circuit board 22 includes a plurality of holes 24, each hole 24 is preferably arranged in parallel and corresponds to the position of the conductive material 11 of each optical cable 10, and the encapsulated light-emitting element is installed around the holes 24 on the printed circuit board 22. Therefore, in the structure of this embodiment, the conductive material 11 of each optical cable 10 passes through the holes 24 to form a structure in which each light-emitting element 20 is arranged surrounding the conductive material 11 of each optical cable 10. In addition, the axis direction of each optical cable 10 is parallel to the Y direction shown in FIG. 3, while the plane direction of the printed circuit board 22 is parallel to the X-Z plane shown in FIG. 3, that is, the printed circuit board 22 and the extension direction of each optical cable 10 are perpendicular to each other.

It should be noted that although in this embodiment, two printed circuit boards 22 are provided, which are respectively located at both ends of the optical cable 10, and all the encapsulated light-emitting elements 20 are mounted on the printed circuit boards 22. However, for the sake of simplicity of the drawing, only one of the printed circuit boards 22 is shown in FIG. 3, while the other printed circuit board has the same or similar structure and is located at the other end of the optical cable. In addition, in other embodiments of the present invention, more (e.g., more than 3) printed circuit boards 22 may be included.

It is worth noting that each encapsulated light-emitting element 20 includes a plurality of light-emitting units 26, each of which is, for example, a light-emitting diode or a laser diode. Preferably, each encapsulated light-emitting element 20 includes light-emitting units capable of emitting three different colors lights, such as red light-emitting diode (LED), a green light-emitting diode and a blue light-emitting diode, or a red laser diode, a green laser diode and a blue laser diode. The above red, green and blue light are the three primary colors of light respectively, so they can be combined into various colors light sources.

In other embodiments of the present invention, the color or number of light-emitting units 26 included in each encapsulated light-emitting element 20 can be adjusted. For example, in some embodiments, the encapsulated light-emitting element 20 includes a monochromatic light source (e.g., one of red, blue, and green light sources or other colors light source), or a bi-color light source (e.g., two of red, blue, and green light sources, or two light sources of any different colors), or four or more light sources of different colors, all of which are within the scope of the present invention.

In this embodiment, as shown in FIG. 2, each light-emitting unit 26 of the encapsulated light-emitting element 20 can emit light L, and the light L irradiates on the light guiding material 12 of each optical cable 10. The light guide material 12 can transmit light (i.e., the light L emitted from the light-emitting unit 26), so that the display device 100 has a uniform light-emitting effect. The light guide material 12 may be an electrical insulating material, and may also be used as an insulating coating material for the conductive material 11 and/or the signal line. In another embodiment, the outer portion of the conductive material 11 may be coated with an insulating material, such as polyethylene or polyvinyl chloride, and then the light guide material 12 may be coated on the outer portion of the insulating material. The insulating material is preferably a white or light color material to increase the reflection or refraction effect of light when transmitted in the light guide material 12.

In the present invention, in order to improve the intensity of light transmission to the light guide material 12, it is preferable to align the position of the light-emitting unit 26 with the position of the light guide material 12. In other words, the light-emitting unit 26 will be located in the area covered by the light guide material 12 as viewed from the sectional view. In other words, the light-emitting unit 26 will overlap the area of the light guide material 12.

In addition, the display device 100 further includes a controller 30 connected to each encapsulated light-emitting element 20 to control each light-emitting unit 26 on the encapsulated light-emitting element 20, such as turning on/off the light source, adjusting the intensity of the light, or combining the light source with a new color by turning on the light source of some colors, for example, turning on red light and blue light simultaneously to combine into purple light, etc., wherein the controller 30 can be electrically connected to the conductive material 11 of at least one optical cable 10 to electrically connect power supply to the controller 30 and each encapsulated light-emitting element 20. In addition, since the encapsulated light-emitting elements 20 are respectively arranged at both ends of each optical cable 10, if the encapsulated light-emitting elements 20 on both sides emit light of different colors, they can be combined into different colors. For example, if the encapsulated light-emitting elements 20 on both sides respectively emit red light and blue light, purple light can be combined in the middle section, and the intensity of red light and blue light on both sides can also be controlled to adjust the position of the purple light section.

In addition, the plurality of optical cables 10 in the present invention can be arranged into the display device 100 and exhibit special display effects (e.g., showing the flow effect of light, or showing some patterns by the principle of visual persistence, etc.).

The controller 30 includes a housing 31. In this embodiment, the housing 31 includes an upper half portion 312 and a lower half portion 314. The upper half portion 312 and the lower half portion 314 can be locked and combined by bolts or buckles to form the housing 31. An accommodating space is formed in the housing 31 to accommodate the printed circuit board 22. In addition, two opposite sides 315 and 316 of the housing 31 form a plurality of through holes H1 and H2 through which the optical cables 10 penetrate into the housing 31 and are clamped and fixed by the upper half portion 312 and the lower half portion 314 of the housing 31.

The display device 100 of the present invention further includes a connector 50, for example, a connector or a port used in computer equipment, commonly including a 6-PIN port or a 24-PIN port, etc., which is suitable for connecting hardware equipment such as a power supply, a motherboard or a display card of a computer, but is not limited thereto. The conductive materials 11 of the optical cables 10 are bonded to the connector 50. Further, the conductive materials 11 of the optical cables 10 are connected to the terminals of the connector 50. In this embodiment, both ends of the optical cables 10 are respectively connected to a connector 50.

It should be noted that although a total of six optical cables 10 are shown in this embodiment, the present invention is not limited thereto. The display device 100 of the present invention may include more or less optical cables, and only two or more optical cables are required to be included in the scope of the present invention. In addition, it is preferable that each optical cable satisfies the condition that both ends are respectively provided with encapsulated light-emitting elements to irradiate light to the optical cable at the same time.

One of the features of the present invention is to provide a display device formed by arranging a plurality of optical cables, wherein both ends of each optical cable 10 are respectively provided with encapsulated light-emitting elements 20. For example, printed circuit boards 22 are respectively arranged at both ends of the optical cable 10, and then at least one encapsulated light-emitting element 20 is respectively arranged on each printed circuit board 22. In addition, the encapsulated light-emitting elements 20 located at both ends of the optical cable 10 may be connected to the same or different controllers 30, respectively. The controller 30 enables the encapsulated light-emitting elements 20 at both ends to respectively emit light to the light guide material 12 of the optical cable 10. Compared with one-sided light emission (only one side is provided with a encapsulated light-emitting element 20), the above-mentioned two-sided light-emitting cable can exhibit various light and shadow effects. However, when the optical cables are arranged into a display device, more light and shadow effects can be displayed. The light and shadow effects of several different embodiments of the display device in the present invention will be described below:

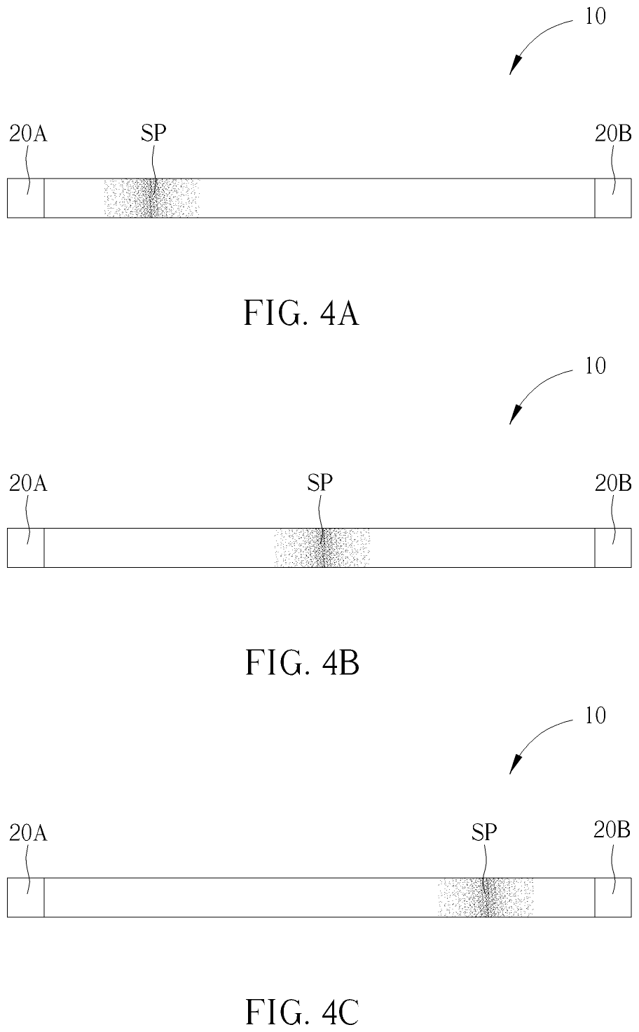

Please refer to FIGS. 4A, 4B and 4C, which show the light and shadow variation effect of a single optical cable in an embodiment of the present invention. FIG. 4A, FIG. 4B and FIG. 4C respectively show the light and shadow effect of the optical cable at different times. First of all, as shown in FIG. 4A, an optical cable 10 is provided with at least one or more encapsulated light-emitting elements on both sides thereof. For convenience of explanation, taking FIG. 4A as an example, the left and right encapsulated light-emitting elements are defined as a encapsulated light-emitting element 20A and a encapsulated light-emitting element 20B, respectively. The two encapsulated light-emitting elements 20A and 20B can emit light of different light intensities and/or different colors into the optical cable 10 (light guide material 12) by a controller respectively.

As shown in FIG. 4A, in this embodiment, the left encapsulated light-emitting element 20A emits weaker light, while the right encapsulated light-emitting element 20B emits stronger light. Because the light intensity decreases with the transmission distance, therefore, as shown in FIG. 4A, a shadow pattern SP is left on the optical cable 10. Since the light intensity from the right side is greater than the light intensity from the left side, the shadow pattern SP is closer to the left side of the optical cable 10. Next, a controller (not shown) adjusts the light intensities of the left and right sides to increase the light intensity of the left side and decrease the light intensity of the right side at the same time. When the light intensities of the left and right sides are approximately the same, a shadow pattern SP can appear as shown in FIG. 4B, i.e., the shadow pattern SP is located substantially in the middle of the optical cable 10, and when the light intensity of the left side is greater than the light intensity of the right side, a shadow effect as shown in FIG. 4C, i.e., the shadow pattern SP is close to the right side. The light and shadow effects of the above-mentioned FIGS. 4A to 4C are presented in sequence, and the light and shadow flowing effect can be presented on the optical cable.

If the above steps are repeated or reversed, the shadow pattern SP can be controlled to repeatedly move rightward, leftward, or leftward and rightward on the optical cable. In the present invention, the luminous intensity of the encapsulated light-emitting element varies with time. For example, in an embodiment of the present invention, the relationship between the light emission intensity of the encapsulated light-emitting element 20A and time is similar to a sine wave, while the relationship between the light emission intensity of the encapsulated light-emitting element 20B and time is similar to a cosine wave, so that the shaded pattern SP can move on the optical cable repeatedly. In addition, if the encapsulated light-emitting elements on both sides emit light of different colors, more various light and shadow effects can be presented. For example, when a plurality of optical cables are parallel, the light and shadow effect similar to water flow or aurora can be displayed.

In another embodiment of the present invention, if the encapsulated light-emitting elements at both ends emit strong light, superposition of lights may occur at the central portion of the optical cable, and a brighter region (which may be defined as a strong light area, not shown in the figure) appears at the central portion, that is, the brightness of the optical cable near the central region is greater than the brightness at both ends. At this time, the optical cable may not have the shaded pattern SP, but the position of the above-mentioned strong light area can still be controlled by adjusting the intensity of light on both sides. Its principle is similar to that of controlling the position of the shadow pattern SP. For convenience of explanation, the following embodiments still take the shadow pattern SP as an example, but it is understood that the shadow pattern mentioned in the embodiments of the present invention can be replaced by the strong light area described herein, which is also within the scope of the present invention.

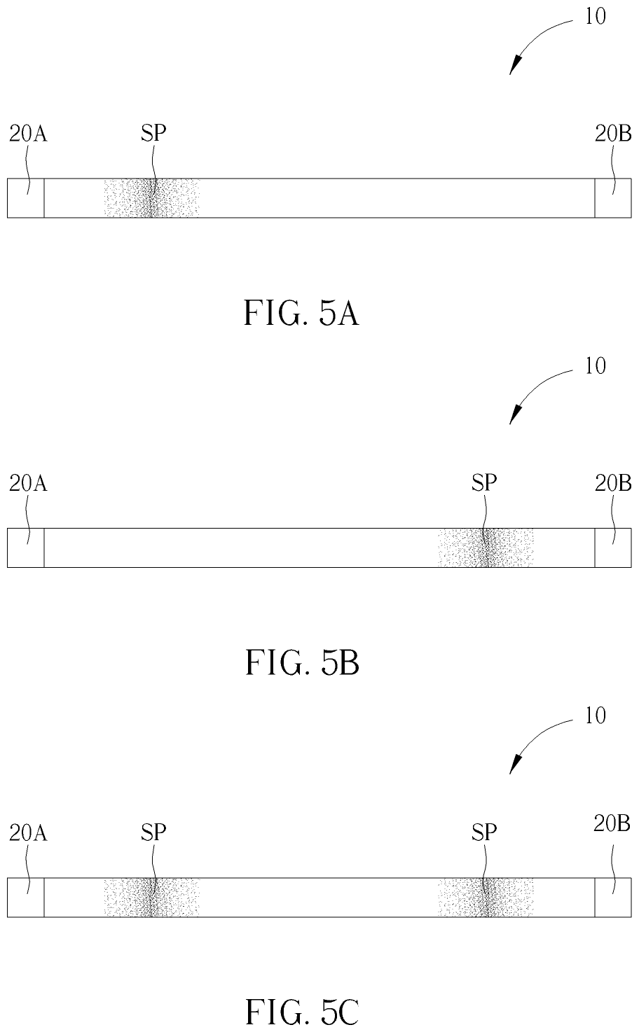

Please refer to FIGS. 5A, 5B and 5C, which are schematic diagrams showing the light and shadow effect of an optical cable in another embodiment of the present invention. FIGS. 5A and 5B respectively show the light and shadow effect of the optical cable at different time points, while FIG. 5C shows the light and shadow effect after the patterns of FIGS. 5A and 5B are combined using the principle of visual persistence. As shown in FIG. 5A, the controller is adjusted to control the encapsulated light-emitting element 20A and the encapsulated light-emitting element 20B respectively, so that the light intensity on the left side of the optical cable is smaller than the light intensity on the right side, and the shadow pattern SP is closer to the left side of the optical cable. At this time, the light and shadow pattern presented by the optical cable is recorded as the first pattern. As shown in FIG. 5B, the controller is adjusted to control the encapsulated light-emitting element 20A and the encapsulated light-emitting element 20B respectively, so that the light intensity on the left side of the optical cable is greater than the light intensity on the right side, and the shadow pattern SP is closer to the right side of the optical cable. At this time, the light and shadow pattern presented by the optical cable is recorded as the second pattern. Then, the first pattern and the second pattern are quickly switched, for example, the two patterns are quickly switched at a frequency of less than 0.1 second. As shown in FIG. 5C, due to the relation of vision persistence, two shadow patterns SP appear simultaneously on the optical cable when the optical cable is observed by human eyes. Therefore, by the above-mentioned method, it is possible to present section light emission on the same optical cable, for example, the section light, dark, light, dark, and light from left to right as shown in FIG. 5C. The above-mentioned light and shadow effects cannot be displayed on the optical cable with only one-sided light emission effect. In other words, due to the continuity of light, if only one-sided light emission is available, more than two shadow sections cannot be displayed on one optical cable at the same time. Therefore, if light sources (encapsulated light-emitting elements) are respectively arranged at both ends of the optical cable, various light and shadow effects can be presented.

In addition, the light and shadow patterns shown in FIG. 5C are formed by combining two light and shadow patterns, i.e., the light and shadow patterns in FIGS. 5A and 5B. However, in other embodiments of the present invention, more than three kinds of light and shadow patterns can form one light and shadow pattern, in other words, more than three kinds of different light and shadow patterns can be preset, and then different light and shadow patterns can be quickly switched, so that the light and shadow patterns can be combined, and the optical cable can present more complex light and shadow patterns. The above embodiments are also within the scope of the present invention.

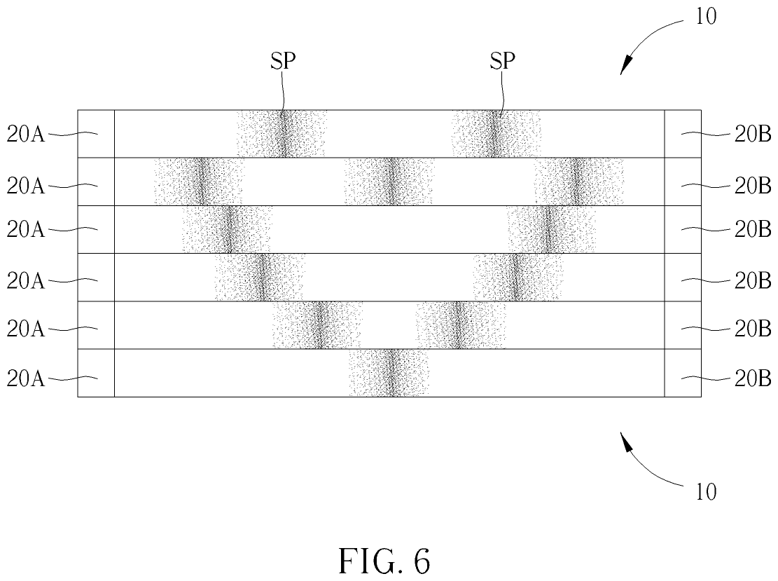

As shown in FIG. 6, applying the light and shadow effect shown in FIG. 5C, when a plurality of optical cables are arranged side by side to form a display device, a simple pattern can be displayed. For example, as shown in FIG. 6, the display device 100 presents a heart-shaped pattern formed by arranging shadow patterns SP, and the above pattern also belongs to an embodiment of the present invention. It can be understood that the present invention is not limited to this, and other patterns can be arranged by using the shadow patterns SP. If the condition of combining the light and shadow patterns based on the visual persistence principle is satisfied, it is within the scope of the present invention.

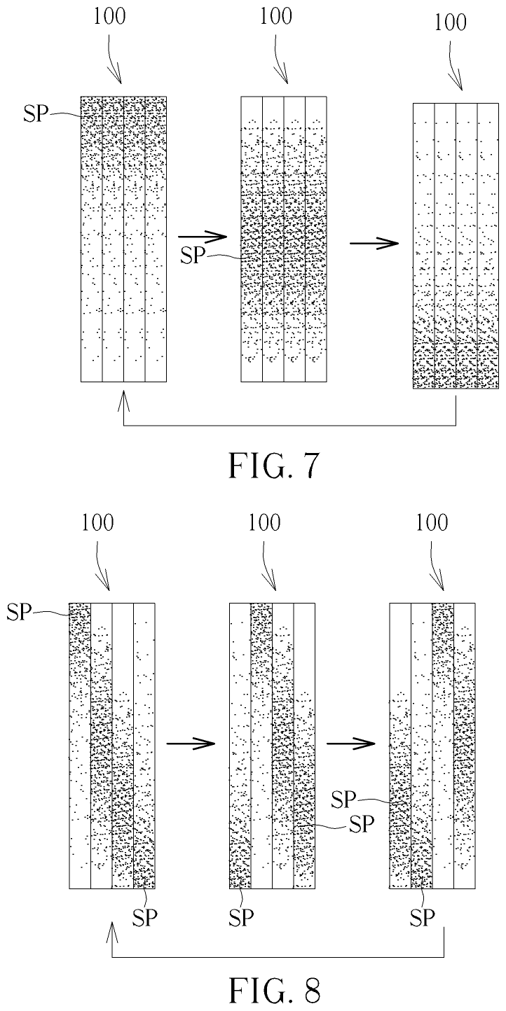

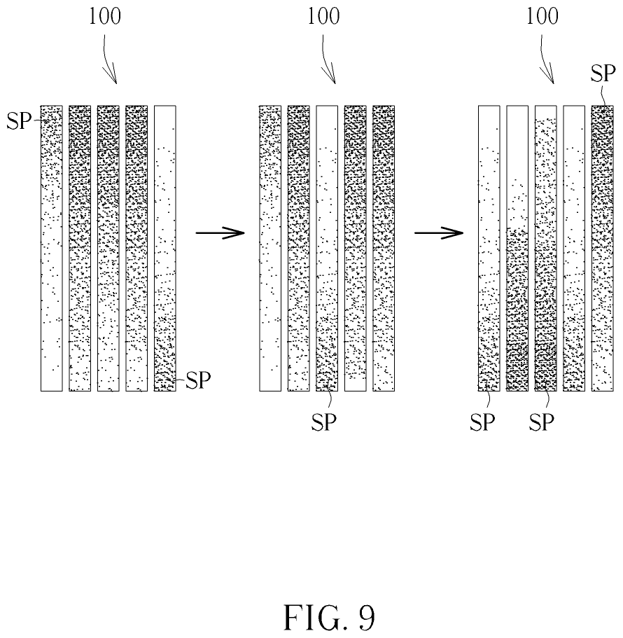

In other embodiments, as shown in FIG. 7, FIG. 8 and FIG. 9, patterns presented by the display device at different times according to different embodiments of the present invention are respectively depicted. In FIG. 7 to FIG. 9, the shadow patterns are sequentially changed along with the direction of the arrows. As shown in FIG. 7, the shadow patterns SP of each optical cable move in parallel toward the same direction, and the shadow patterns SP can be arranged to resemble water flow. As shown in FIG. 8, the shadow patterns SP of each optical cable move sequentially in the same direction, and the shadow patterns SP can be arranged in a spiral-like effect. As shown in FIG. 9, the shadow pattern SP of each optical cable moves randomly, and the shadow pattern SP can be arranged to resemble aurora. The above-mentioned effects of various light and shadow effects are within the scope of the present invention.

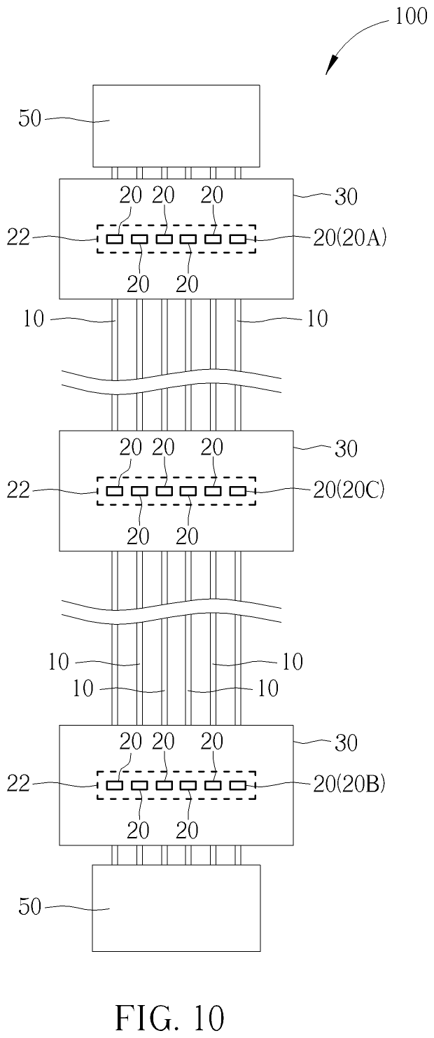

In other embodiments of the present invention, as shown in FIG. 10, FIG. 10 shows an upper view of a display device according to another preferred embodiment of the present invention. If the length of the optical cable is long, it may cause the problem that the light is not easily transmitted to the other end completely. At this time, more than one middle light-emitting element 20C can be additionally arranged between the encapsulated light-emitting element 20A and the encapsulated light-emitting element 20B at both ends, so that the above-mentioned problem of light transmission can be solved, and the light can completely cover the entire optical cable. In addition, the middle light-emitting element 20C can be used as a dividing point to separate different light-emitting sections on the optical cable. For example, the section between the encapsulated light-emitting element 20A and the middle light-emitting element 20C can exhibit one light-shadow effect, while the section between the encapsulated light-emitting element 20B and the middle light-emitting element 20C can exhibit another light-shadow effect.

In addition, in other embodiments of the present invention, the number of the optical cables (similar to parallel arrangement) may be increased, or the optical cables may be connected in series with other optical cables (similar to series arrangement) to increase the area and resolution of the display device. For example, the six optical cables shown in FIG. 1 are defined as one light-emitting module unit, and a plurality of light-emitting module units are arranged into 4×4 light-emitting modules in series and parallel, so that the area and resolution of the display device can be further increased. Understandably, the number of light-emitting modules connected in series or in parallel is only an example and can be adjusted according to actual requirements.

In summary, one of the features of the present invention is to provide a display device and an operation method thereof, wherein the display device is formed by arranging a plurality of optical cables. Both ends of the same optical cable are respectively provided with encapsulated light-emitting elements, thus achieving the effect of double-sided light emission. Compared with the single-sided light-emitting optical cable, the double-sided light-emitting optical cable has more changes in the presentation of light and shadow effects, and has various light and shadow effects that cannot be presented by single-sided light-emitting optical cable. Therefore, the beauty and value of the product can be increased. In addition, the display device can also display various light and shadow effects or specific patterns according to requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a plurality of optical cables arranged parallel with each other, wherein each optical cable wire comprises a conductive material and a light guide material, wherein the light guide material covers the conductive material; and
two encapsulated light-emitting elements comprising a first encapsulated light-emitting element and a second encapsulated light-emitting element, which are respectively positioned at two ends of each optical cable wire, wherein each encapsulated light-emitting element comprises a plurality of light-emitting units, and an area of each light-emitting unit overlaps with an area of the light guide material when viewed from a cross-sectional direction.

2. The display device according to claim 1, further comprising a second optical cable which is arranged in parallel with the optical cable and comprises two other encapsulated light-emitting elements which are respectively positioned at two ends of the second optical cable.

3. The display device according to claim 1, wherein the light-emitting unit on each of the encapsulated light-emitting elements comprises a red light-emitting diode, a green light-emitting diode and a blue light-emitting diode.

4. The display device according to claim 1, further comprising a controller electrically connected to the encapsulated light-emitting elements and controlling the light-emitting units on the encapsulated light-emitting elements to emit the light.

5. The display device according to claim 1, wherein each of the encapsulated light-emitting elements is located in a housing.

6. The display device according to claim 1, wherein each encapsulated light-emitting element is located on a printed circuit board, and the optical cables pass through the printed circuit board, wherein an axial direction of the conductive material of the optical cables is perpendicular to a surface of the printed circuit board.

7. The display device according to claim 1, further comprises a third encapsulated light-emitting element, which is arranged at a middle section of the optical cable and is positioned between the first encapsulated light-emitting element and the second encapsulated light-emitting element.

8. An operation method of a display device, comprising:
providing a display device, comprising:
a plurality of optical cables arranged parallel with each other, wherein each optical cable wire comprises a conductive material and a light guide material, wherein the light guide material covers the conductive material; and
two encapsulated light-emitting elements comprising a first encapsulated light-emitting element and a second encapsulated light-emitting element, which are respectively positioned at two ends of each optical cable wire, wherein each encapsulated light-emitting element comprises a plurality of light-emitting units, and an area of each light-emitting unit overlaps with an area of the light guide material when viewed from a cross-sectional direction; and
controlling the first encapsulated light-emitting element and the second encapsulated light-emitting element so that the first encapsulated light-emitting element and the second encapsulated light-emitting element respectively emit light into the light guide material.

9. The operation method of a display device according to claim 8, wherein the first encapsulated light-emitting element and the second encapsulated light-emitting element respectively emit light of different colors into the light guide material.

10. The operation method of a display device according to claim 8, wherein after the first encapsulated light-emitting element and the second encapsulated light-emitting element respectively emit light to the light guide material, both end portions of the light guide material are brighter, and an intermediate portion of the light guide material is darker.

11. The operation method of a display device according to claim 8, wherein after the first encapsulated light-emitting element and the second encapsulated light-emitting element respectively emit light to the light guide material, both end portions of the light guide material are darker, and an intermediate portion of the light guide material is brighter.

12. The operation method of a display device according to claim 8, wherein after the first encapsulated light-emitting element and the second encapsulated light-emitting element respectively emit light to the light guide material, a controller controls the light-emitting intensity of the first encapsulated light-emitting element to be smaller than the light-emitting intensity of the second encapsulated light-emitting element, so that a first shaded area in the light guide material is close to one end of the first encapsulated light-emitting element, and the pattern presented by the light guide material is recorded as a first pattern.

13. The operation method of a display device according to claim 12, wherein after the first encapsulated light-emitting element and the second encapsulated light-emitting element respectively emit light to the light guide material, the controller controls the light-emitting intensity of the first encapsulated light-emitting element to be greater than the light-emitting intensity of the second encapsulated light-emitting element, so that a second shaded area in the light guide material is close to one end of the second encapsulated light-emitting element, and the pattern presented by the light guide material is recorded as a second pattern.

14. The operation method of a display device according to claim 13, wherein the controller enables the first pattern and the second pattern to be quickly switched and simultaneously presents the first shadow area and the second shadow area on the light guide material.

15. The operation method of a display device according to claim 8, wherein the brightness of light emitted by the first encapsulated light-emitting element or the second encapsulated light-emitting element changes with time.

16. The operation method of a display device according to claim 8, wherein the display device can be arranged in series or parallel with another display device and combined into a display device with larger area.
